(19) United States
(12) Patent Application Publication
(10) Pub. No.: US 2026/0226981 A1
(43) Pub. Date: Aug. 6, 2026

(54) Actuation Assembly for a Transmission

(71) Applicant: ZF Friedrichshafen AG, Friedrichshafen (DE)

(72) Inventors: Hagen Doepfert, Lindau (DE); Michel Wiemer, Weingarten (DE); Thomas Riedisser, Sigmarszell (DE)

(21) Appl. No.: 19/152,760

(22) PCT Filed: Jan. 29, 2024
(86) PCT No.: PCT/EP2024/052015

§ 371 Date: Jul. 31, 2025

(30) Foreign Application Priority Data
Jan. 31, 2023 (DE) 10 2023 200 743.6

(51) Int. Cl. F16H 63/40; F16H 63/18

(52) U.S. Cl. CPC F16H 63/40; F16H 63/18

(57) ABSTRACT

An actuating arrangement for a gearbox including at least one shift drum and a pawl, where the pawl is swivelably mounted. When the shift drum is rotated, the pawl is pressed out of engagement with a shift element part of a shift element of the gearbox to actuate the shift element. The actuating arrangement comprises at least one means for reducing friction force during actuation of the shift element.

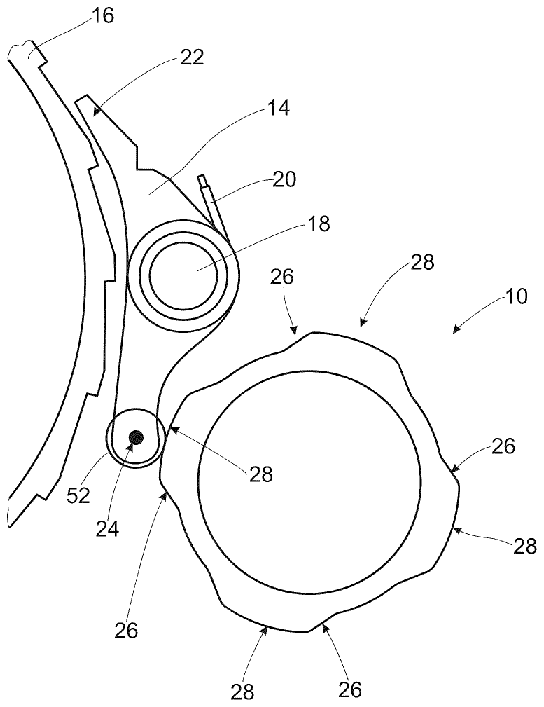

### CROSS-REFERENCE TO RELATED APPLICATION

The present application is related and has right of priority to German Patent Application No. 10 2023 200 743.6 filed on Jan. 31, 2023 and is a nationalization of PCT/EP2024/052015 filed in the European Patent Office on Jan. 29, 2024, both of which are incorporated by reference in their entirety for all purposes.

### FIELD OF THE INVENTION

The present invention relates generally to an actuating arrangement for a gearbox. The invention also relates generally to a vehicle.

### BACKGROUND

Many gearboxes are shifted using shift drums. By rotation of the shift drum, different shift elements are, for example, centrally shifted in order to provide a desired gear. For example, depending on the rotational position of the shift drum, different rotary elements of planetary gear sets of the gearbox are connected to each other for conjoint rotation. Due to the rotational motion, an engagement of a pawl with a shift element part is releasable. Due to the applied drive torque, however, a high torque can result, which is supported against the engagement of the pawl. As a result, a high actuating torque can be necessary during the release to rotate the shift drum and, thus, to change gears or “gear ratios” in the gearbox. Depending on the selected gear ratio, the actuating torque may increase even further. This actuating torque can be unpleasant for the operator and result in incorrect operation or impede a gear ratio change in general. If the shift drum is rotated by a servo, the servo can be large and expensive in order to provide sufficient power, as the servo must be designed for the highest load in order to enable reliable shifting.

### SUMMARY OF THE INVENTION

A first aspect of the invention relates to an actuating arrangement for a gearbox. A gearbox is a device that transmits a drive torque from a drive input to a drive output. The gearbox, for example, transmits the drive torque from a motor to a tire of a vehicle. The gearbox can be designed to shiftably provide different gears for transmitting torque. To this end, the gearbox has, for example, respective spur gear stages and, alternatively or additionally, respective planetary gear sets. The gearbox is, for example, a gearbox of a bicycle. The gearbox is therefore, for example, a hub gear or a bottom bracket gearbox. A gear or “gear ratio” provides, for example, a fixed transmission ratio between an input and an output of the gearbox.

The actuating arrangement has a shift drum. The shift drum is a component, the actuation of which brings about a gear change of the gearbox. For example, the shift drum is rotatable in order to actuate different shift elements. Via the shift drum, the gears of the gearbox can be sequentially shifted through, for example, centrally by one single actuation.

The actuating arrangement has a swivelably mounted pawl. The pawl is swivelably mounted, for example, on a housing of the gearbox, for example, by a pin. In some instances, the actuating arrangement has multiple pawls, which are mounted together on the pin or separately. When the shift drum is rotated, the pawl is pressed out of an engagement with a shift element part in order to actuate a shift element of the gearbox. As a result, a gear change is carried out. In certain positions of the shift drum, the pawl can enter into engagement with the shift element part. To this end, the pawl is preloaded with a spring, for example, in the direction of the shift element part. “Depending on the gear” can also relate to a current gear, a gear change, or even a gear that is being engaged.

A shift element of the gearbox connects, for example, two elements of the gearbox, such as rotary elements of a planetary gear set or shafts of a spur gear stage, to one another for conjoint rotation. For example, by actuating a shift element, the shift element is movable between a disengaged state and an engaged state. In the disengaged state, the shift element cannot, for example, transmit a torque. In the engaged state, the shift element can, for example, transmit a torque. A shift element is, for example, an interlocking clutch or a friction-locking clutch. A shift element can function as a brake, by which a movable part of the gearbox is rotationally fixable.

The shift element part is, for example, one half of a clutch of the shift element. The shift element part is rotatable, for example, at least in certain gears of the gearbox, when a drive torque is applied. The shift element part can be supported against the pawl, for example, at least in certain gears, and thus be prevented from rotating. The pawl can be a movable part that is swiveled when acted upon by the shift drum. To this end, one end of the pawl is in contact with the shift drum. Another end of the pawl engages with the shift element part. For example, in one gear, the pawl is in engagement with external teeth on the shift element part, out of which engagement the pawl is pressed by the shift drum in order to change to another gear. The shift element part has teeth, for example, on its outer circumference, for the engagement with the pawl. The shift element part is, for example, a brake ring.

The shift drum has, for example, a drum body. The drum body is formed, for example, from a metal material. The drum body has, for example, a cylindrical basic shape.

The shift drum can have respective actuation regions for pressing the pawl out of the engagement with the shift element part. An actuation region protrudes, for example, from a region of the drum body that is adjacent in the circumferential direction. An actuation region is formed, for example, by one side of a cam of the drum body. When the shift drum is rotated, for example, an actuation region presses against the pawl and, thus, disengages the pawl from the shift element part. Depending on the angular position of the shift drum, the pawl can be pressed out of the engagement with the shift element part. Certain rotational angular positions of the shift drum can each correspond to one gear of the gearbox. For example, the engagement of the pawl with the shift element part is released both in a first gear ratio and in a second gear ratio.

However, in further gears, for example, a third gear ratio, the pawl is engaged with the shift element part.

The actuating arrangement has at least one means for reducing friction force during the actuation of the shift element. In some instances, the means relates to a structural configuration of the actuating arrangement. In one or more instances, the means is a mechanical configuration of the actuating arrangement. A friction force is induced by a relative motion of two parts of the actuating arrangement during the rotation of the shift drum, or during a gear change or an actuation of the shift element, and counteracts an actuating force. For example, the shift drum gliding on the end of the pawl facing the shift drum can cause such a counteracting friction force. This friction force is reduced by the means for reducing friction force as compared to actuating arrangements without such a means. As a result, an actuating force and also an actuating torque for actuating the shift element is particularly low. In some instances, the means for reducing friction force is a coefficient of friction-reducing measure between two parts of the actuating arrangement that are movable in relation to one another.

In some instances, the shift drum actuates multiple pawls. In one instance, the pawls are arranged axially next to one another. For example, one axial region of the shift drum is provided for each pawl, which axial region has actuation regions associated with the corresponding pawl. As a result, multiple shift elements are actuatable for a gear change. For example, the gearbox has two shift elements, each of which has an assigned pawl. The pawls can thus be jointly brought out of an engagement with an associated shift element part by the shift drum, depending on the gear.

In one embodiment of the actuating arrangement, the means for reducing friction force includes mounting of at least one movable part of the actuating arrangement by a roller bearing. Via the roller bearing, the associated movable part is mountable on a stationary part or another movable part of the actuating arrangement. Movable parts of the actuating arrangement are, for example, the pawl, the shift drum, and the pin. Immovable parts of the actuating arrangement are, for example, the housing and the pin. A roller bearing is particularly suitable as a means for reducing friction force, since actuating speeds are low, or the movable parts move at a low speed. The friction with roller bearings is relatively independent of speed in comparison to sliding bearings. In addition, a roller bearing has low friction even at low relative speeds. In some instances, a roller bearing has an inner ring, an outer ring, and rolling elements located therebetween, which rolling elements roll during a relative motion of the outer ring and the inner ring. For example, the rolling elements are balls or cylinders. The roller bearing is, for example, a single-row ball bearing or a double-row ball bearing. The roller bearing is, for example, a cylindrical roller bearing or a needle bearing. In addition, a cage is providable for the rolling elements. In one or more instances, the actuating arrangement has multiple roller bearings as means for reducing friction force.

In one embodiment of the actuating arrangement, the shift drum is mounted by a roller bearing as a means for reducing friction force. As a result, an actuating torque for rotating the shift drum for all gears and angular positions is directly reduced. For example, the shift drum is rotatably mounted on the housing of the gearbox by the roller bearing. In some instances, the housing is part of the actuating arrangement. The housing has, for example, a cover and a housing body and forms an interior space. In some instances, the actuating arrangement and respective shift elements are accommodated in the interior space of the housing. The shift drum is mounted, for example, at each axial end using a roller bearing.

In one embodiment of the actuating arrangement, the pawl is mounted by a roller bearing as a means for reducing friction force. As a result, a torque for rotating the pawl is particularly low. As a result, a spring for preloading the pawl in the direction of the shift element part also has particularly small dimensions. For example, the pawl is rotatably mounted on the pin by the roller bearing. The pin is, for example, fixed or rotatably mounted on the housing. In some instances, the pin is part of the actuating arrangement. In one instance, the roller bearing is fastened directly on the pawl, for example, with an inner ring or an outer ring of the roller bearing.

In one embodiment of the actuating arrangement, the pawl is mounted on a pin and the pin is rotatably mounted by a roller bearing as a means for reducing friction force. For example, the pin is rotatably mounted on the housing by the roller bearing.

The pawl is, for example, non-rotatably mounted on the pin. Such a design is low-cost when only one pawl is non-rotatably mounted on the pin. In some instances, the pin is part of the actuating arrangement.

In one embodiment of the actuating arrangement, the pawl is rotatably mounted on the pin. As a result, actuating forces are even lower. In addition, in some instances, multiple pawls are thus fastened on the pin and are swivelable independently of one another. For example, at most one of the plurality of pawls is non-rotatably connected to the pin, while the other pawls, as described above, are rotatably mounted on the pin by a roller bearing.

In one embodiment of the actuating arrangement, the pawl is non-rotatably mounted on the pin. In some embodiments, if at least two pawls are provided, one pawl is non-rotatably mounted on the pin and one pawl is rotatably mounted on the pin. For example, the pawl is non-rotatably connected to the pin by an interference fit or by a securing pin. Due to the non-rotatable mounting, a low-cost and simple design results when there is only one pawl, which is mounted on one single pin.

In one embodiment of the actuating arrangement, the pawl has a rotatable roller as means for reducing friction force. In some instances, the rotatable roller rolls on an actuation region of the shift drum, for example, when the shift drum is rotated, in order to press the pawl out of the engagement with the shift element part. As a result, friction between the shift drum and the pawl is particularly low, as a result of which actuating torques are also particularly low. The roller is arranged, for example, on an end region of the pawl that faces the shift drum. An oppositely located region of the pawl forms the engagement region of the pawl with the shift element part. The roller is arranged so as to be in contact with the shift drum, for example, with the outer circumferential surface of the drum body. The roller is supported, for example, by a roller bearing. As a result, friction and, thus, an actuating force, can be even lower. In some instances, the roller is formed by the roller bearing. For example, an outer ring of the roller bearing forming the roller then rolls on the shift drum. As a result, particularly few parts are required.

In one embodiment of the actuating arrangement, the means for reducing friction force is at least one pairing of frictional surface materials between two surfaces of a first part and of a second part of the actuating arrangement, which surfaces are at least partially in contact with one another and are movable relative to one another during the actuation of the shift element. In some instances, a pairing of frictional surface materials corresponds to the material of a first surface and of a second surface, wherein the surfaces glide on one another, causing a friction force. For instance, the first surface is a surface of the first part and the second surface is a surface of the second part. In such instance, the means therefore relates to the material selection for these surfaces. In some instances, the surface is formed, for example, by a coating on the part. In one instance, the surface is formed, for example, by a material of the part that forms the body of the part. This material can be changed, not only via its selection, but also by a surface treatment as a means for reducing friction force, for example, a surface hardening. In one example, a pair of surfaces that are in contact with one another during the actuation of the shift element and are movable relative to one another are formed, for example, by the shift drum as the first part and the pawl as the second part. In an example, a pair of surfaces that are in contact with one another during the actuation of the shift element and are movable relative to one another are formed, for example, by the shift drum as the first part and the housing as the second part. In some instances, a pair of surfaces that are in contact with one another during the actuation of the shift element and are movable relative to one another are formed, for example, by the housing as the first part and the pawl as the second part. In one instance, a pair of surfaces that are in contact with one another during the actuation of the shift element and are movable relative to one another are formed, for example, by the pin as the first part and the pawl as the second part. In some embodiments, a pair of surfaces that are in contact with one another during the actuation of the shift element and are movable relative to one another are formed, for example, by the pin as the first part and the housing as the second part. In some instances, the corresponding material pairings are selected for minimizing friction force and, alternatively or additionally, treated. For example, instead of two steel materials, one steel material with an aluminum material are provided as the pairing of frictional surface materials. For example, an aluminum material is hard-anodized for minimizing friction. A hard-anodized aluminum shift drum has, for example, an advantage with respect to friction as compared to a non-anodized aluminum shift drum when there is sliding-friction contact between the shift drum and the pawl.

In one embodiment of the actuating arrangement, the pairing of frictional surface materials corresponds to a material of the first part and to a material of the second part of the actuating arrangement, wherein, during operation of the gearbox, no propulsive force transmitted via the gearbox is introduced into at least the first part. With respect to the first part, lower loads thus result, and so, for example, a softer material can be selected therefor than for a second part, into which a propulsive force transmitted via the gearbox is introduced during operation of the gearbox. The propulsive force corresponds, for example, to a torque transmitted by the motor. For example, only a low force is supported against the shift drum. By comparison, for example, when the shift element part and the pawl can be acted upon by the propulsive force when the pawl is brought into engagement with the shift element part, such parts should therefore not be formed from a soft material. A material forming the first part is for example, a material other than the material forming the second part.

In one embodiment of the actuating arrangement, for the pairing of frictional surface materials, one of the two parts has a base material and a surface material. In one instance, the surface material forms at least a first surface of the surfaces that are in contact with one another and are movable relative to one another during the actuation of the shift element. The surface material therefore specifies the coefficient of friction. By comparison, in some instances, the base material is irrelevant for the coefficient of friction during the gliding on one another. For example, the surface material, in comparison to the base material, has a lower coefficient of friction with a second surface of the surfaces that are in contact with one another and are movable relative to one another during the actuation of the shift element. As a result, the friction is particularly low. In order to reduce costs, for example, only a portion of an outer surface of the part of the actuating arrangement is formed by the surface material and a remaining outer surface is formed by the base material. In some instances, the remaining outer surface cannot come into contact with other surfaces that are movable relative thereto, for example, during the actuation of respective shift elements.

In one embodiment of the actuating arrangement, the shift drum is the part having the base material and the surface material. In this case, the surface material forms, for example, a contact surface of the shift drum with the pawl and, alternatively or additionally, the housing. As a result, a torque for rotating the shift drum is particularly low.

For example, the shift drum has a base material and a surface material. In some instances, the surface material and the base material differ from one another. In one instance, the surface material forms at least one actuation region. For some instances, the surface material, in comparison to the base material, has a lower coefficient of friction with a material of the pawl coming into contact with the shift drum. As a result, an actuating force for disengaging the pawl is reduced due to reduced friction between the pawl and the shift drum. The surface material differs from the base material, for example, due to a material, a crystal structure, and, alternatively or additionally, a doping. For example, the surface material is formed by a coating, or additionally or alternatively by a surface treatment of the base material. Due to the combination of surface material and base material, a low-cost, lightweight and, alternatively or additionally, robust material can be selected as the base material, regardless of its friction with the pawl, without this resulting in an increased actuating force.

For example, a portion of the surface of the drum body is formed by the base material. For example, an end face of the shift drum is formed by the base material. Alternatively, or additionally, in some instances, a region of the surface of the drum body can also be formed by the base material, similarly to a region of the circumferential surface that does not form an actuation region. Therefore, for example, coating material is conserved or a surface treatment is limited to small regions.

In one embodiment of the actuating arrangement, the actuating arrangement has a housing of the gearbox. The housing corresponds, for example, to the above-described housing. The housing is, for example, a cast component or a steel component. In some instances, the housing is the part having the base material and the surface material. In one instance, the surface material forms, for example, a mounting for the pin and, alternatively or additionally, the shift drum.

In one embodiment of the actuating arrangement, the actuating arrangement has the shift element part. In some instances, the actuating arrangement also has the entire shift element. In one instance, the actuating arrangement also has the housing. In some embodiments, the gearbox and the shift element are also components that are different or separate from the actuating arrangement. For some instances, the shift element is part of the gearbox.

A second aspect relates to a vehicle having a gearbox that has the actuating arrangement according to the first aspect. Respective further features, embodiments and advantages are found in the descriptions of the first aspect. Conversely, features, embodiments and advantages of the second aspect are also features, embodiments and advantages of the first aspect.

A shift element of the gearbox is actuatable by the actuating arrangement. In some instances, the vehicle is a bicycle, for example, an e-bike, a pedelec, a velomobile, a cargo bike, or the like. In one instance, the gearbox is a bicycle gearbox.

The gearbox is, for example, a hub gear or a bottom bracket gearbox. The shift element is thus actuatable using particularly low force, which facilitates its use. Specifically with respect to bicycles, shift elements are typically manually actuated, for example, by rotating the shift drum by a shift lever via a shift cable. The shift lever can therefore be small and the actuating force can accordingly be low. Even when shifting is carried out by a servo, the servo can thus be small and low-cost.

### BRIEF DESCRIPTION OF THE DRAWINGS

The present invention is explained in greater detail in the following with reference to the sole FIGURE, wherein:

The FIGURE schematically illustrates an actuating arrangement for a gearbox having a shift drum.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

The FIGURE illustrates an actuating arrangement for a bicycle gearbox. The actuating arrangement has a shift drum 10 including a drum body, a pawl 14, and a shift element part 16 as a brake ring. The pawl 14 is swivelably mounted on a pin 18 and is preloaded into an engagement with the shift element part 16 by a spring element 20. An end region 22 of the pawl 14 facing away from the shift drum 10 engages into teeth on the shift element part 16 when the shift drum 10 does not press the pawl 14 away from the shift element part 16 and, thus, out of the engagement.

This actuation of the pawl 14 takes place depending on the gear ratio selected by rotation of the shift drum 10 about its longitudinal axis, which corresponds to a central axis of the drum body and extends into the plane of the drawing. The drum body has four cam-like protrusions 28 on its outer circumferential surface. An end region 24, opposite the end region 22 and facing the shift drum 10, glides on the outer circumferential surface of the shift drum 10 during rotation of the shift drum 10. When one of the cam-like protrusions 28 is reached, the pawl 14 is pressed out of the engagement with the shift element part 16 by a flank 26 during an exemplified rotation in the counterclockwise direction of the shift drum 10.

The cam-like protrusions 28 and the flanks 26 all have the same shape in the actuating arrangement shown in the FIGURE. The shift drum 10 is therefore symmetrical. The shift drum 10 must overcome a friction force between the end region 22 of the pawl 14 and the contacted tooth flank of the shift element part 16 in order to change gears by releasing the engagement of the pawl 14 with the shift element part 16. This yields a corresponding shift torque for rotating the shift drum 10. This also yields a friction force that holds the pawl 14 in the engagement with the shift element part 16. This friction force must be overcome by the shift torque in order to shift gears. In addition, the shift torque must overcome all other friction forces between two parts that are in contact with one another and are moved relative to one another due to the actuation.

In the actuating arrangement, multiple means are provided for reducing friction force during actuation of the shift element by rotation of the shift drum 10. For instance, the shift drum 10 is rotatably mounted on a housing of the gearbox by a roller bearing (not shown). As another example, the end region 24 of the pawl 14 is formed by an additional roller 52, which, in the example shown, is a roller bearing and mounted on a pin of the pawl 14. Via the roller 52, the pawl 14 rolls on the outer circumferential surface of the drum body of the shift drum 10. To this end, an outer ring of the roller bearing forming the roller 52 is in contact with the outer circumferential surface of the drum body of the shift drum 10. As a result, friction between the shift drum 10 and the pawl 14 is lower in comparison to an actuating arrangement without such a roller 52. As a result, a shift torque for changing gears or an actuating torque for rotating the shift drum 10 is reduced. As another example, in some instances, the pawl 14 is mounted on the pin 18 by a roller bearing. As a further example, in some instances, the pin 18 is mounted on the housing of the gearbox by a roller bearing.

In addition, in one embodiment, an aluminum shift drum 10 is hard-anodized in the region in which the roller 52 rolls on its rolling element. In an alternative embodiment, the shift drum is formed from steel. In some instances, the outer ring of the roller 52 is made of steel. The shift drum 10 is a first part of the actuating arrangement and forms a first surface. The outer ring of the roller 52 of the pawl 14 is a second part of the actuating arrangement and forms a second surface. These two surfaces are in contact with one another and move relative to one another during the actuation of the shift element. Due to the means for reducing friction force, the friction during the actuation of the shift element and, thus, the actuating force is particularly low.

In one instance, a roller 52 is not provided. Instead, the end region 24 of the pawl 14 has direct sliding-friction contact with the shift drum 10. In this instance, the hard anodization of the shift drum 10 formed from aluminum brings about particularly greatly reduced friction between the shift drum 10 and the pawl 14 as compared to a shift drum 10 without such hard anodizing.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 shift drum
14 pawl
16 shift element part
18 pin
20 spring element
22 end region
24 end region
26 flank
28 protrusions
52 roller

1-15. (canceled)

16. An actuating arrangement for a gearbox, the actuating arrangement comprising:
at least one shift drum (40); and
a pawl (14), the pawl (14) being swivelably mounted,
wherein, when the shift drum (10) is rotated, the pawl (14) is pressed out of engagement with a shift element part (16) of a shift element of the gearbox to actuate the shift element,
wherein the actuating arrangement comprises at least one means for reducing friction force during actuation of the shift element.

17. The actuating arrangement of claim 16, wherein the at least one means for reducing friction force comprises at least one roller bearing for mounting at least one movable part of the actuating arrangement.

18. The actuating arrangement of claim 17, wherein the at least one movable part of the actuating arrangement rotatably mounted by the at least one roller bearing comprises the shift drum (10).

19. The actuating arrangement of claim 17, wherein the at least one movable part of the actuating arrangement rotatably mounted by the at least one roller bearing comprises the pawl (14).

20. The actuating arrangement of claim 17, wherein the at least one movable part of the actuating arrangement rotatably mounted by the at least one roller bearing comprises a pin (18), the pawl (14) being mounted on the pin (18).

21. The actuating arrangement of claim 20, wherein the pawl (14) is rotatably mounted on the pin (18).

22. The actuating arrangement of claim 20, wherein the pawl (14) is non-rotatably mounted on the pin (18).

23. The actuating arrangement of claim 16, wherein the at least one means for reducing friction force comprises a rotatable roller (52) of the pawl (14), the rotatable roller (52) rolling on an actuation region of the shift drum (10) to press the pawl (14) out of engagement with the shift element part (16).

24. The actuating arrangement of claim 16, wherein the at least one means for reducing friction force comprises a pairing of frictional surface materials between a first surface of a first part of the actuating arrangement and a second surface of a second part of the actuating arrangement, the first surface and the second surface being at least partially in contact and movable relative to one another during the actuation of the shift element.

25. The actuating arrangement of claim 24, wherein the pairing of frictional surface materials comprises a first material of the first part and a second material of the second part, wherein, during operation of the gearbox, no propulsive force transmitted via the gearbox is transmitted to the first part.

26. The actuating arrangement of claim 24, wherein the pairing of frictional surface materials comprises a base material and a surface material, the first part comprising the base material and the surface material, the surface material forming at least part of the first surface, the surface material having a lower coefficient of friction than the base material with the second surface.

27. The actuating arrangement of claim 26, wherein the shift drum (10) is the first part comprising the base material and the surface material.

28. The actuating arrangement of claim 26, further comprising a housing of the gearbox, the housing being the first part comprising the base material and the surface material.

29. The actuating arrangement of claim 16, further comprising the shift element part (16).

30. A vehicle comprising a gearbox, which has the actuating arrangement of claim 16, wherein a shift element of the gearbox is actuatable by the actuating arrangement.
